(19) United States
(12) Patent Application Publication
(10) Pub. No.: US 2007/0116350 A1
(43) Pub. Date: May 24, 2007

(54) Method for detecting the alignment of films for automated defect detection

(76) Inventor: Mark Allen Cheverton, Mechanicville, NY (US)

Correspondence Address: CANTOR COLBURN, LLP, 55 GRIFFIN ROAD SOUTH, BLOOMFIELD, CT, 06002, US

(21) Appl. No.: 11/285,330

(22) Filed: Nov. 21, 2005

(51) Int. Cl. G06K 9/00

(52) U.S. Cl. 382/151

(57) ABSTRACT

Disclosed herein is a method comprising acquiring an image of a display film or a mold with a camera; transferring the image to a computer; detecting an angle of alignment and/or a position of the display film or the mold from the image; detecting coordinates of defects located in the display film or the mold; and correcting the coordinates of the defects by compensating for the angle of alignment and/or the position of the display film or the mold.

### BACKGROUND

This disclosure relates to methods for detecting the alignment of display films or molds that are used to manufacture the display films. Detecting the alignment can be further used to facilitate automated defect detection.

In backlight computer displays or other display systems, optical films are often used to direct light. For example, in backlight displays, light management films use prismatic structures to direct light along a viewing axis (i.e., an axis substantially normal to the display). These prismatic structures are referred to as microstructure. Directing the light enhances the brightness of the display viewed by a user and allows the system to consume less power in creating a desired level of on-axis illumination. Films for turning or directing light can also be used in a wide range of other optical designs, such as for projection displays, traffic signals, and illuminated signs.

The prismatic structures are generally formed in a display film by replicating the prismatic structures present on a metal tool or a mold via processes such as stamping, molding, embossing, or UV-curing. It is generally desirable for the display film and the mold to be free from defects so as to facilitate a uniform luminance of light. Since the prismatic structures serve to strongly enhance the brightness of a display, any defects, even if they are small (on the order of 10 microns), can result in either a very bright or very dark spot on the display, which is undesirable. The mold and the display films are therefore inspected to eliminate defects.

In order to determine and eliminate defects in a display film, it is desirable to be able to orient images of successive films manufactured on a given production line in an identical direction for purposes of inspection. By orienting the images of successive display films in identical directions during an inspection, defects located at substantially identical positions or locations on the display film or on the mold can be identified and eliminated. The location of defects in substantially identical positions on successive display films can further result in improved quality control processes thereby eliminating such defects.

In order to accomplish the detection of defects, the display film or the mold is first placed on the sample holder of the inspection system, and aligned manually using a fixture that holds the film in the sample holder. Since the alignment is made manually, it is generally inaccurate. Additional adjustments to improve alignment are difficult to accomplish especially for the display films, since display films are easily damaged upon being subjected to movement.

Automated inspection systems are therefore generally used in order to minimize such manual movement of the display films. Automated inspection systems generally comprise a digital camera that takes an image of a film. The image of the film is then imported into a control system such as a computer where defects can be identified and located. However, misaligned films can once again give rise to problems since alignment seams present on the structured display film move into the field of view of the camera and are falsely identified as defects.

It is therefore desirable to have an automated inspection system where the angle at which the display film is positioned is accurately detected so that the defect coordinates can be accurately corrected thereby making it possible to eradicate alignment marks from the images.

### SUMMARY

Disclosed herein is a method comprising acquiring an image of a display film or a mold with a camera; transferring the image to a computer; detecting an angle of alignment and/or a position of the display film or the mold from the image; detecting coordinates of defects located in the display film or the mold; and correcting the coordinates of the defects by compensating for the angle of alignment and/or the position of the display film or the mold.

Disclosed herein is a method comprising disposing a display film or a mold in a fixture in a sample holder; acquiring an image of a display film or a mold with a camera; transferring the image to a computer; detecting a fiducial mark in the image of the display film or the mold; cropping the fiducial mark from the image of the display film or the mold; detecting an angle of alignment and/or a position of the display film or the mold from the image; detecting coordinates of defects located in the display film or the mold; and correcting the coordinates of the defects by compensating for the angle of alignment and/or the position of the display film or the mold.

Disclosed herein is a method comprising disposing a display film or a mold in a fixture in a sample holder; acquiring an image of the display film or the mold with a camera; transferring the image to a computer; detecting a fiducial mark in the image of the display film or the mold; cropping the fiducial mark from the image of the display film or the mold; detecting an angle of alignment and/or a position of the display film or the mold from the image; detecting coordinates of a defect located in the display film or the mold; correcting the coordinates of the defect by compensating for the angle of alignment and/or the position of the display film or the mold; filtering a defect based on defect size; and recording characteristics of a defect to a memory device.

Disclosed herein too is an automated inspection system comprising a control device; a transmission light disposed below a sample holder for illuminating defects in a display film or a mold placed on the sample holder; a reflection light disposed above the sample holder for illuminating defects in the display film or the mold; and a low resolution camera in electrical communication with the control device; wherein the control device executes an algorithm that permits the automated inspection device to perform a method comprising acquiring an image of a display film or a mold with a camera; transferring the image to a computer; detecting an angle of alignment and/or a position of the display film or the mold from the image; detecting coordinates of defects located in the display film or the mold; and correcting the coordinates of the defects by compensating for the angle of alignment and/or the position of the display film or the mold.

### DESCRIPTION OF FIGURES

FIG. 1 is a schematic depicting an automated inspection device 10;

FIG. 2 is a schematic depicting the sample holder 2;

FIG. 3 is a schematic depiction of the functions of the algorithm that facilitate defect detection in display films;

FIG. 4 is a schematic depicting a display film in the sample holder 2;

FIG. 5 is a photomicrograph exemplifying defects observed by a low resolution camera and a high resolution camera; and

FIG. 6 is a photograph showing the useful area of the display film; it also shows the seam and the alignment fiducials.

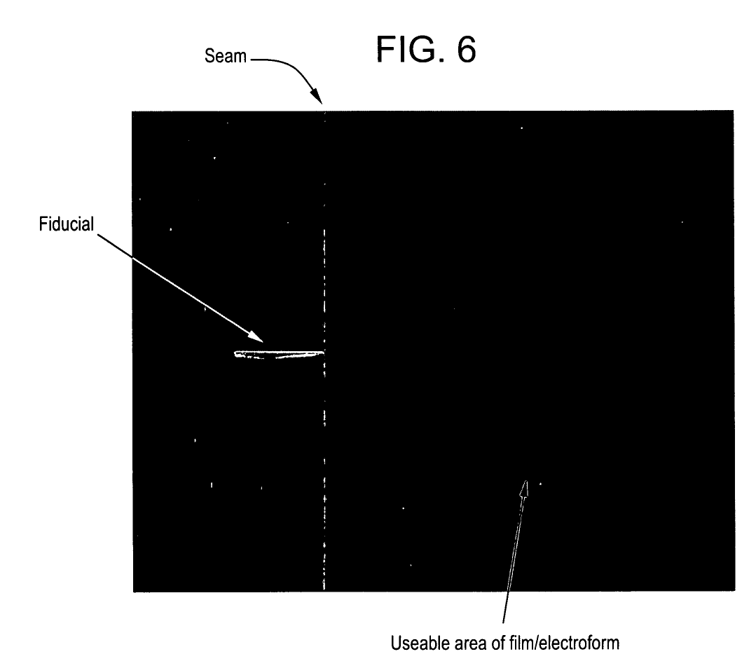

### DETAILED DESCRIPTION

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and independently combinable.

Detailed herein is an automated inspection system wherein the angles and/or positions at which the display film and/or the mold are located in the sample holder are accurately detected so that the orientation of the display film and/or the mold can be accurately determined. In one embodiment, the automated detection system uses an algorithm that comprises a set of equations that facilitate a rotation of coordinates of the image of the display film, thereby reorienting the image and compensating for the angle of alignment. The automated detection system determines the angle of alignment as well as the position of the display film and/or the mold in the sample holder and determines the original coordinates of the display film or the mold. It then uses the algorithm to recompute the coordinates thereby removing the effect of the angle of alignment. The new coordinates (obtained after the recomputation) pertain to a system of universal coordinates that permit the location of defects on successive display films or molds to be compared with each other. The accurate detection of the angles at which the film is positioned permits the eradication of alignment marks from the images. It also permits the accurate location of the defects in the display film and/or the mold, which advantageously permits the permanent elimination of the defects from the display film and/or the mold.

In one embodiment, the method comprises acquiring an image of a display film or a mold with a camera; transferring the image to a computer; detecting the angle of alignment and/or the position of the display film from the image; detecting the coordinates of defects located in the display film or the mold; and correcting the coordinates of the defects by compensating for the angle of alignment or compensating for the position.

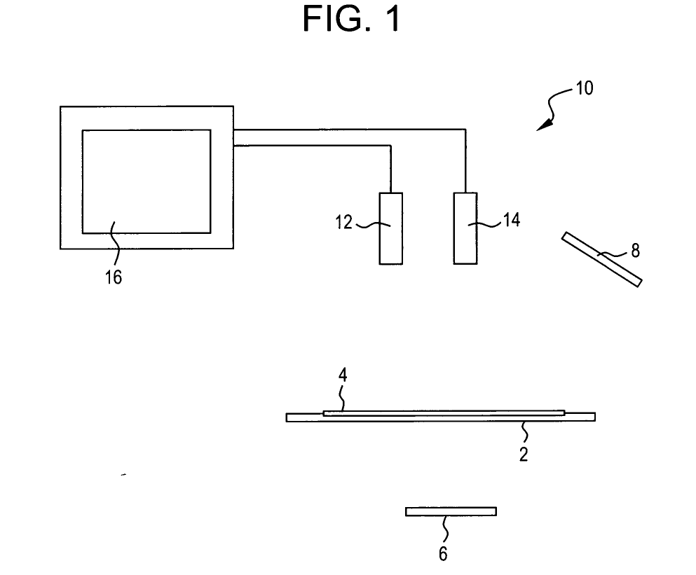

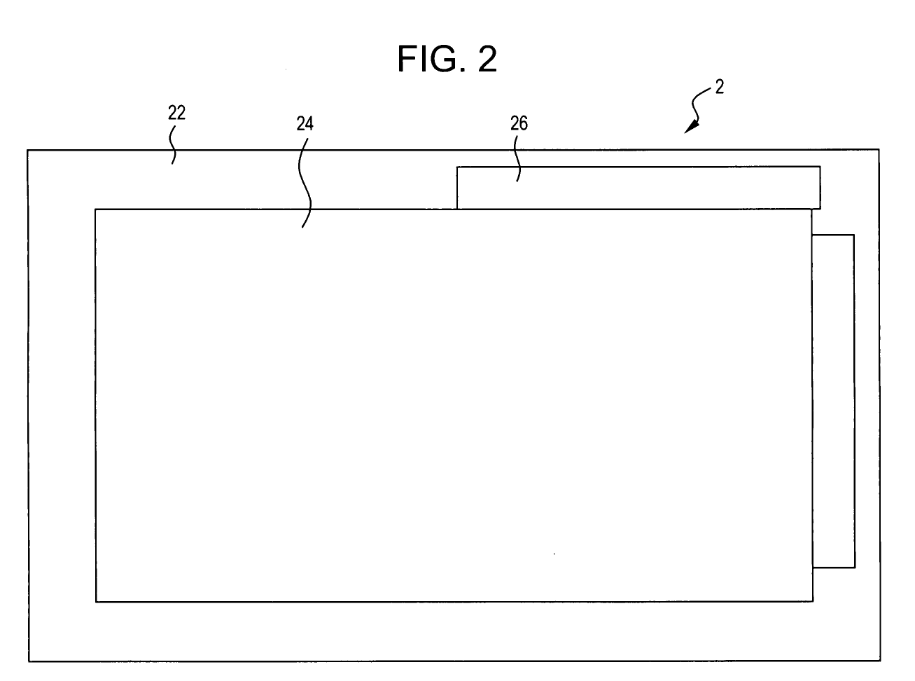

With reference now to the FIG. 1, an automated detection system 10 comprises a sample holder 2 upon which the display film 4 to be inspected is placed. The display film 4 is held by a fixture (not shown) in the sample holder 2. FIG. 2 depicts an exemplary embodiment of the sample holder 2 that comprises a metal fixture 22, a glass plate 24 for placing the display film 4 or the mold (not shown), and alignment guides 26 for aligning the display film 4 or the mold. The mold may be cylindrical, curvilinear or flat. The mold is a tool that is used to manufacture the display film 4. In an exemplary embodiment, the mold is an electroform that is used to manufacture the display film 4.

With reference now again to the FIG. 1, a transmission light 6 is placed below the sample holder 2, while a reflection light 8 is placed above the sample holder 2. The transmission light 6 as well as the reflection light 8 are both used to illuminate the display film 4 in order to examine it for defects. The arrangement and the intensity of the lighting can be used to create different backgrounds against which the defects are illuminated. The automated detection system further comprises a low resolution scanning camera 12 and a high resolution camera 14 respectively that are used to capture images of the display film 4 or the mold and transmit these images to a control system 16. An exemplary control system 16 is a computer.

Upon placing the display film 4 or the mold in the sample holder 2, an image is first acquired with the low resolution scanning camera. An optional image can be obtained with the high resolution camera 14 if desired. Since the area of the field of view of the camera is less than that of the area of the display film or the mold, the camera generally makes multiple passes across the film or the mold in order to image the entire area of the display film or the mold. The camera generally makes multiple passes across the display film 4 or mold to cover the entire area of inspection.

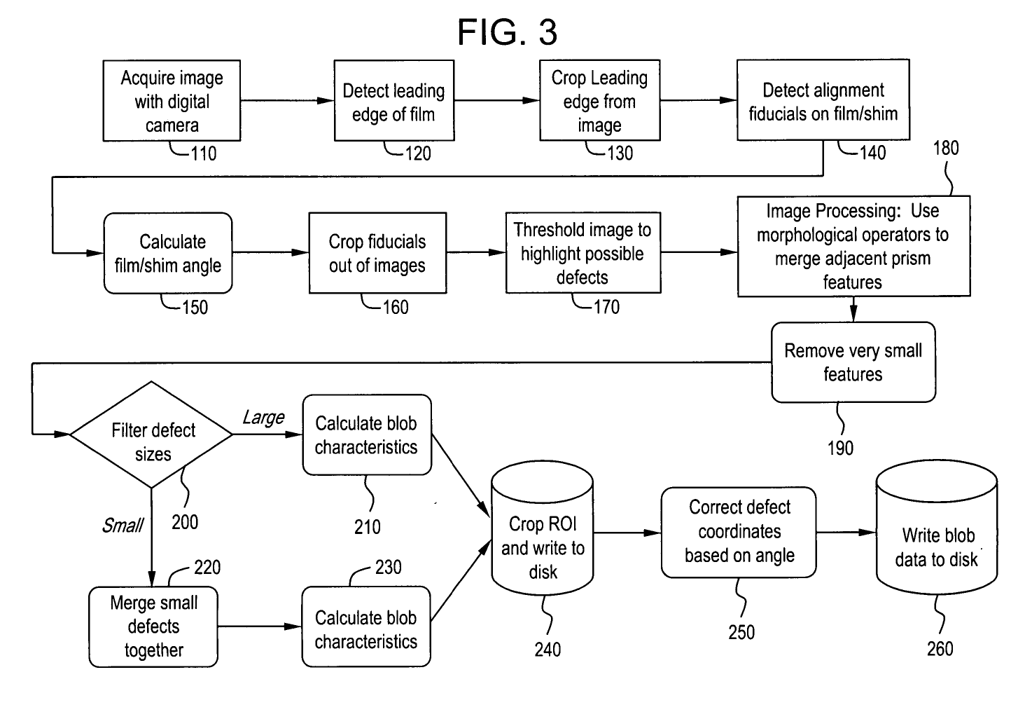

Following capture of the image, the automated detection system uses an algorithm to accomplish a series of process actions that result in identifying and removing a number of defects from the display film or the mold. A process diagram for the automated detection system is displayed in the FIG. 3. As can be seen in the FIG. 3, following the capture of the image 110, the defect detection algorithm performs a sequence of actions comprising detecting the leading edge of the display film or the mold 120, cropping the leading edge from the image of the display film 130, detecting fiducial marks present on the display film 140, calculating the film/mold angle 150, cropping the fiducial marks out of the image 160, highlighting possible defects 170, image processing to remove small features 180, 190, followed by a number of defect detection actions 200-230 that are detailed below. After detecting the coordinates of the defects, the data is saved to a memory storage system 240. The step numbers shown above and in the FIG. 3 are not indicative of the order in which the algorithm performs the various processes depicted in the figure, but are used only for purposes of identifying the various steps.

As noted above, the automated detection system is designed so that the camera captures at least 10 images of the display film or the mold. In another embodiment, the automated detection system is designed so that the camera captures at least 20 images of the display film or the mold. In yet another embodiment, the automated detection system is designed so that the camera captures at least 40 images of the display film and/or the mold. In an exemplary embodiment, the camera captures approximately 40 images of the display film or the mold. In this exemplary embodiment, 10 images are captured in 4 passes across the display film or the mold.

It is desirable to capture the leading edge of the film or the mold (i.e., the edge where the film or the mold begins) in at least one pass of the camera across the display film. In one embodiment, the camera captures the leading edge of the film or the mold during the first pass across the display film or the mold. Capturing the image of the leading edge of the film or the mold during the first pass across the display film or the mold permits the computer of the automated detection system to determine where the inspection area for the display film or the mold begins. This helps to minimize detecting false defects outside the useful area of the display film or the mold. Detection of the leading edge of the film is also useful because it facilitates the accurate determination of the defect coordinates. The accuracy of the coordinates is desirable when the film is die punched to different desired sizes/shapes depending upon customer preferences. It is generally desired to position the die so that defects can be cut from the film, thereby increasing production yields.

The useful area of the display film is that area which is used for collimating light during the display of an image on a liquid crystalline display device such as a television or computer screen. The useful area of the display generally comprises prismatic structures to refract the diffused light so that the light will be incident perpendicularly on the liquid crystal display surface. The useful area of the mold is that area that is comprises prismatic structures that are stamped into the display film. If false defects outside the useful area of the display film or the mold are inadvertently recognized by the automated inspection system, post processing of the data may have to be undertaken to remove these extraneous effects. This reduces the efficiency of the process and increases processing time. Once the leading edge of the display film or the mold is detected, the region outside the useful area is cropped from the image so that false defects are not detected and analyzed further.

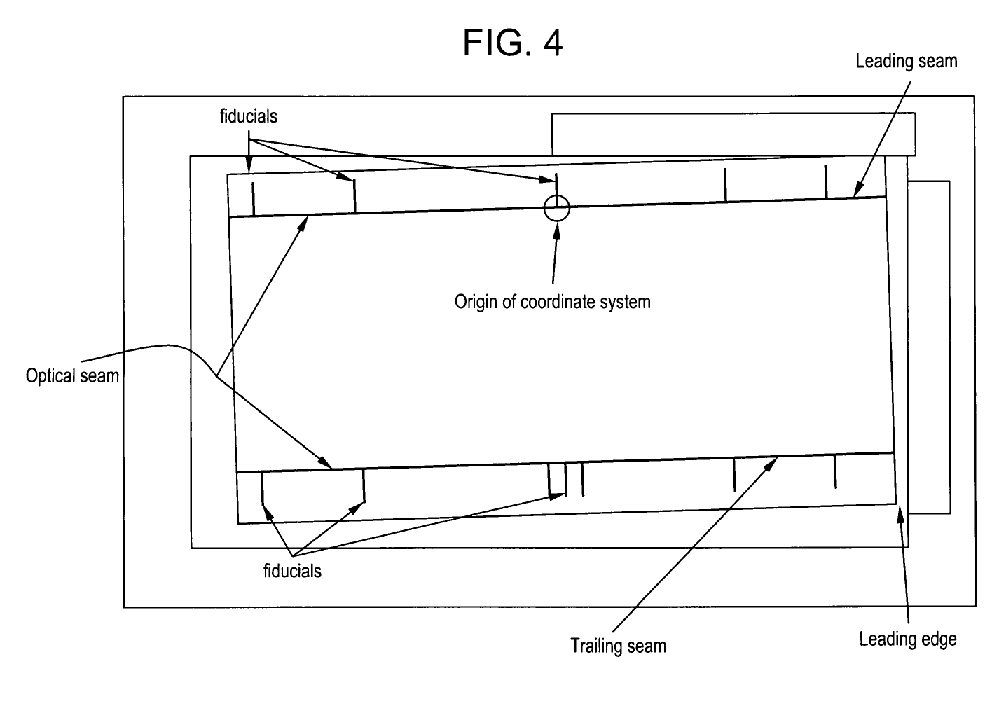

In an exemplary embodiment, the useful area of the display film is that area that is bounded by a seam that is created by the fiducial marks. The fiducial marks are demonstrated in the FIG. 4 and comprise a series of inverted “T” marks on a first side of the length of the film and a series of “T” marks on a second side that is opposed to the first side. As may be seen in the FIG. 4, the series of the “T” marks on either side along the length of the film give rise to the seam. In other words, the bottoms of the “T” marks along the first side or the top of the “T” marks along the second side constitute the seam.

With reference now to the FIG. 4, the fiducial marks are used to define the origin of the coordinate system, from which the defect coordinates are measured. The fiducial marks are detected along the edge of the display film. FIG. 4 indicates the position of the seam and the alignment fiducials on the display film. In one embodiment, in order to detect the fiducial marks, the camera does an extra pass across the display film mounted on the sample holder prior to the inspection.

As noted in the FIG. 3, once the fiducial mark is detected in step 140 and imaged, the computer determines the coordinates (end-points) of the fiducial marks. The coordinates of the fiducial marks are then used to determine the angle and/or the position at which the display film is aligned on the fixture of the sample holder. This is performed at step 150. Once the angle and/or the position at which the film is aligned is detected, the image of the seam along with images of portions of the display film outside the useful area can be cropped (i.e., eliminated from the image). The elimination of the seam and other areas that lie outside the useful area from the image remove the possibility of detecting false defects in the film.

In an exemplary embodiment, detecting the position of one or more fiducial marks on each side permits the determination of the position and/or the angle of the display film or the mold. In another exemplary embodiment, detecting the position of one or more fiducial marks on opposing sides of the display film or the mold permits the determination of the position and/or the angle. In another exemplary embodiment, detecting two or more fiducial marks on each side of the display film or the mold permits the determination of the position and/or the angle.

Once the angle of alignment or the position of the display film or the mold is determined in step 150 and the areas outside the useful area are eliminated in step 160, the image is subjected to analysis to identify defects present in the display film in steps 170 through 230. There are a variety of defects that occur in the display film or the mold. With regard to the display film there are two types of defects namely integral and removable defects. Integral defects are defects that are caused because of defects that are inherent in the mold. Such integral defects are caused by physical damage that is present on the mold. These defects are generally called scratches, dashes or separation marks.

Removable defects are superficial defects, which are often called stains, dust, spiders, blue spots or whiskers. These defects are caused by the presence of removable debris on the mold. If these defects are tended to before the parent mold is reproduced into daughter molds it will greatly improve the overall yield. A parent mold is the first template made from a given form, while the daughter mold are reproductions of the parent mold that are generally manufactured using the parent mold as a template. If both removable and/or integral defects are missed during inspections of the mold they will translate into defects in the display film. Such defects will be repeated during the manufacturing process as display films are mass-produced using the defective molds and will reduce the overall yield for producing advanced display films.

Defect determination in steps 170 through step 230 is made by assessing the intensity of the defect as well as the size of the defect. Defects that are brighter than an intensity threshold and larger than an area threshold are counted as defect and recorded in the defect report. Defects that have a size and/or area that are below the threshold are ignored, not counted as defects, and not included in the inspection report. This way, non-defective regions of the product are ignored by the detection algorithm. Following the identification of defect clusters, morphological operators in the algorithm are used to merge adjacent prisms on the display film or the mold together (step 180). During the manufacturing of prisms on the display film, the edges of the adjacent prisms often get scratched thereby producing defects. Prism damage defects from adjacent prisms appear as multiple bright spots very close to each other. The image processing algorithm merges these adjacent prism tips together so that this defect is counted only once.

Defects below the size specification limit are then removed from the data set in steps 190 and 200. The size specification limit is determined by the customer, as to what size defects are acceptable in the product. The specification limit is that in general, any defect below a size of 0.15 millimeters is acceptable. The defects are calculated by dividing the sum of the length of defect and the width of defect by 2. Defects above the specification limit are then classified into large defects and small defects, so that each class can be processed using different algorithms. For purposes of reporting, defects above the size limit are separated into three size categories, large, medium, and small. Small defects are about 0.15 to about 0.5 millimeters in size, medium defects are about 0.5 to about 1 millimeter in size, and large defects are greater than 1 millimeter in size.

Defects may also be eliminated based on the intensity of light scattered from a particular defect or combination of defects. If a intensity of light scattered by a particular defect is less than a selected threshold value, then the defect may be acceptable. In one embodiment, the defects may also be eliminated based upon a combination of size and the intensity of light scattered from a particular defect or combination of defects.

Following the classification of defects, each class of defects in the image is examined for their physical characteristics such as, for example, size, dimensions, aspect ratio, orientation, distance from the surface, or the like. In one embodiment, it is possible to get a cluster of very small defects that are localized in a small area of the display film or the mold. Each defect by itself would be too small to be counted and would normally be removed from the image as part of the background. However, since these defects are clustered together, the collection of defects is noticeable and is counted as a single defect. This is performed in step 220. The software measures the distance between small defects, and if this distance is below a certain limit, the small defects are clustered together and counted as a single defect. Such merged defects are called clusters or blobs. After the software clusters the defects together into a blob, the characteristics for each blob are computed. The coordinates for each defect and for each blob is also determined.

Since the alignment angle is accounted for, the automated detection system now assigns coordinates to each defect and/or blob that is based on a system of universal coordinates (i.e., coordinates that are normalized for alignment angle). In other words, the coordinates of the defect are now transformed into a system of coordinates so that the axes of the new coordinate system (hereinafter universal coordinates) can be universally applied to any display film that is placed on the sample holder. In one embodiment, one of the axes of the universal coordinate system is parallel to one edge of the display film or one edge of the mold while also being perpendicular to one edge of the display film or one edge of the mold. The universal coordinates for each defect and/or blob are then saved to a memory device such as a disk or hard drive in step 260. An optional inspection report can be generated along with a defect map displaying the location of the defects using either the original coordinates or the universal coordinates.

The software then uses the defect coordinates to crop a small region of interest (ROI) of the defect out of the total image, and save this ROI image to disk. As a result, there is an ROI saved to disk for each defect. This image of the defect along with its coordinates can be used as a fingerprint to identify similar defects that may be present in successive display films that are produced from the same mold.

The algorithm used in the automated detection system has a number of advantages. As noted above, the algorithm advantageously permits detection of the fiducial marks of the film and normalizes the coordinates of the image of the display film to a system of universal coordinates that are identical for all display films of a given size that are inspected. Since the coordinates for defects can be determined on a universal coordinate system, the automated detection system can therefore be used to identify repeated defects in a display film or on molds. The automated detection system advantageously allows for these defects to be classified and the source of the defects identified. Corrective action can then be used to remove the defect or to minimize its presence in the display film or on the mold.

In one embodiment, the ability of the automated detection system to detect the fiducial marks of the film is advantageous because it makes the determination of the defect coordinates more accurate. The accuracy of the coordinates is desirable when the film is die punched to the desired size/shape for the customer. It is desired to position the die so that defects can be cut from the film, increasing production yields.

In another embodiment, the ability of the automated detection system can be used to facilitate the use of the best sections of the film for use in liquid crystalline displays. The display films for liquid crystalline displays are all die punched to a specific size and shape depending upon the preferences of the customer. As a result, knowing where the defects are accurately is useful, so that the die can be positioned to punch out the best portion of the film. The detection of seams and defects is advantageous for purposes of obtaining the best sections of display film for commercial use.

The following examples, which are meant to be exemplary, not limiting, illustrate compositions and methods of manufacturing of some of the various embodiments of the electrically conductive compositions described herein.

### EXAMPLE

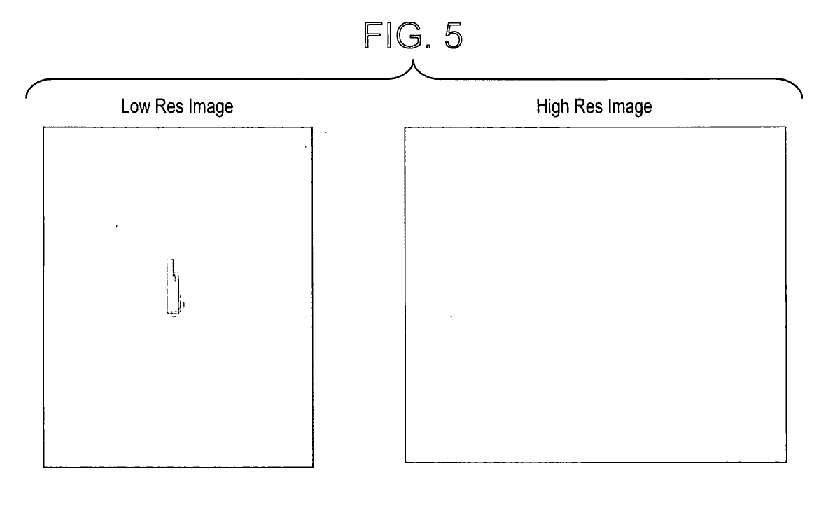

These examples demonstrate the use of the automated detection system to detect defects. They also demonstrate the ability of the automated detection system to determine the coordinates of a particular defect. The image taken by the low resolution scanning camera as well as the high resolution camera was analyzed using the automated detection system. After detecting and cropping the fiducial marks of the image of the display film and removing small features, the image was processed. From the FIG. 5, it can be seen that the image from low resolution camera shows a single bright spot that pertains to a defect. However, the image from the high resolution camera indicates that there are three bright spots that are adjacent to each other that contribute to a single low resolution defect. The three bright spots may pertain to three adjacent defects. The automated detection system has the ability to merge these three small defects into a single defect and to calculate the blob characteristics.

In general, it is possible for a defect to appear as one single defect in the low resolution image, but appear a separate prism tip defects in the high resolution image. The scanning of the film is done with the low-resolution camera, and the high-resolution camera is used for defect classification so that corrective actions can be employed. The high-resolution image is used for operators to view the defect for classification purposes only. The merging of adjacent prism tips is used on the low-resolution images only.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A method comprising:
acquiring an image of a display film or a mold with a camera;
transferring the image to a computer;
detecting an angle of alignment and/or a position of the display film or the mold from the image;
detecting coordinates of defects located in the display film or the mold; and
correcting the coordinates of the defects by compensating for the angle of alignment and/or the position of the display film or the mold.

2. The method of claim 1, further comprising disposing the display film or the mold in a fixture in a sample holder.

3. The method of claim 1, further comprising detecting a fiducial mark in the image of the display film or the mold.

4. The method of claim 3, further comprising cropping the fiducial marks from the image of the display film or the mold.

5. The method of claim 1, wherein the correcting of the coordinates is accomplished by transferring coordinates of the defects to a system of universal coordinates.

6. The method of claim 1, wherein the detecting and correcting of the coordinates is automatically performed by an algorithm.

7. The method of claim 1, further comprising highlighting some defects present in the image while eliminating other defects present in the image.

8. The method of claim 1, further comprising filtering defects based on defect size.

9. The method of claim 1, further comprising filtering defects based on intensity of light scattered from a defect.

10. The method of claim 1, further comprising merging adjacent defects.

11. The method of claim 1, wherein characteristics of the defect as well as coordinates of the defect are recorded to a memory device.

12. The method of claim 11, wherein the characteristics are size, aspect ratio, orientation, dimensionality or a combination comprising at least one of the foregoing characteristics.

13. The method of claim 1, further comprising generating an inspection report and a defect map.

14. The method of claim 1, further comprising locating a source of the defects and eliminating the source.

15. The method of claim 1, wherein the mold is flat, curvilinear or cylindrical

16. An article employing the method of claim 1.

17. A method comprising:
disposing a display film or a mold in a fixture in a sample holder;
acquiring an image of a display film or a mold with a camera;
transferring the image to a computer;
detecting a fiducial mark in the image of the display film or the mold;
cropping the fiducial mark from the image of the display film or the mold;
detecting an angle of alignment and/or a position of the display film or the mold from the image;
detecting coordinates of defects located in the display film or the mold; and
correcting the coordinates of the defects by compensating for the angle of alignment and/or the position of the display film or the mold.

18. The method of claim 17, wherein the correcting of the coordinates is accomplished by transferring coordinates of the defects to a system of universal coordinates.

19. The method of claim 17, wherein the detecting and correcting of the coordinates is automatically performed by an algorithm.

20. The method of claim 17, further comprising highlighting some defects present in the image while eliminating other defects present in the image.

21. The method of claim 17, further comprising filtering defects based on defect size and/or based on intensity of light scattered from a defect.

22. The method of claim 17, further comprising merging adjacent defects.

23. The method of claim 17, wherein characteristics of the defect as well as coordinates of the defect are recorded to a memory device.

24. The method of claim 23, wherein the characteristics are size, aspect ratio, orientation, dimensionality, or a combination comprising at least one of the foregoing characteristics.

25. An article employing the method of claim 1.

26. A method comprising:
disposing a display film or a mold in a fixture in a sample holder;
acquiring an image of the display film or the mold with a camera;
transferring the image to a computer;
detecting a fiducial mark in the image of the display film or the mold;
cropping the fiducial mark from the image of the display film or the mold;
detecting an angle of alignment and/or a position of the display film or the mold from the image;
detecting coordinates of a defect located in the display film or the mold;
correcting the coordinates of the defect by compensating for the angle of alignment and/or the position of the display film or the mold;
filtering a defect based on defect size; and
recording characteristics of a defect to a memory device.

27. The method of claim 26, further comprising merging adjacent defects into a single defect.

28. An article employing the method of claim 26.

29. An automated inspection system comprising:
a control device;
a transmission light disposed below a sample holder for illuminating defects in a display film or a mold placed on the sample holder;
a reflection light disposed above the sample holder for illuminating defects in the display film or the mold; and
a low resolution camera in electrical communication with the control device; wherein the control device executes an algorithm that permits the automated inspection device to perform a method comprising:
acquiring an image of a display film or a mold with a camera;
transferring the image to a computer;
detecting an angle of alignment and/or a position of the display film or the mold from the image;
detecting coordinates of defects located in the display film or the mold; and
correcting the coordinates of the defects by compensating for the angle of alignment and/or the position of the display film or the mold.
